(19) United States
(12) Patent Application Publication
(10) Pub. No.: US 2024/0312370 A1
(43) Pub. Date: Sep. 19, 2024

(54) FRAMELESS FOLD-OVER CARDSTOCK PRINT DISPLAY ARTICLE

(71) Applicant: FUJIFILM North America Corporation, Valhalla, NY (US)

(72) Inventor: Devin Perpetua, Warwick, NY (US)

(73) Assignee: FUJIFILM North America Corporation, Valhalla, NY (US)

(21) Appl. No.: 18/602,688

(22) Filed: Mar. 12, 2024

Related U.S. Application Data
(60) Provisional application No. 63/490,019, filed on Mar. 14, 2023.

(51) Int. Cl. G09F 1/06

(52) U.S. Cl. CPC G09F 1/06

(57) ABSTRACT

A frameless fold-over print display article is provided. The article comprises a panel sheet having top and bottom surfaces bounded by a top edge, a bottom edge, a left side edge and a right side edge. The panel sheet defines a plurality of score lines that, when folded, form a closed three-dimensional construction that defines the frameless fold-over print display article.

### CROSS-REFERENCE TO RELATED APPLICATIONS

This application claims the benefit of U.S. Patent Application No. 63/490,019, filed on Mar. 14, 2023, the contents of which are hereby incorporated by reference in their entirety.

### FIELD OF THE INVENTION

The present invention is related to a frameless fold-over print display article, and more specifically related to a panel layout and method for assembling a cardstock to form the frameless print display article.

### SUMMARY OF THE INVENTION

In one aspect, the invention provides a frameless fold-over print display article comprising a panel sheet having a top surface and a bottom surface bounded by a top edge, a bottom edge, a left side edge and a right side edge. The panel sheet defines a plurality of score lines that, when folded, form a closed three-dimensional construction that defines the frameless fold-over print display article.

### BRIEF DESCRIPTION OF THE DRAWINGS

The above-mentioned and other features and advantages of this invention, and the manner of attaining them, will become apparent and be better understood by reference to the following description of the invention in conjunction with the accompanying drawing, wherein:

FIG. 1 is a front perspective view showing an exemplary print display article produced in accordance with an aspect of the present invention;

FIG. 2 is a plan view of a panel sheet configured to produce the exemplary print display article shown in FIG. 1;

FIG. 3 is a plan view showing a detailed plan view of the panel sheet shown in FIG. 2; and

FIGS. 4A-4C are views of a front panel (FIG. 4A); top, bottom and side panels (FIG. 4B); and a back panel (FIG. 4C) of the exemplary display article shown in FIG. 1 after printing and folding of the panel sheet.

### DETAILED DESCRIPTION OF THE EMBODIMENTS

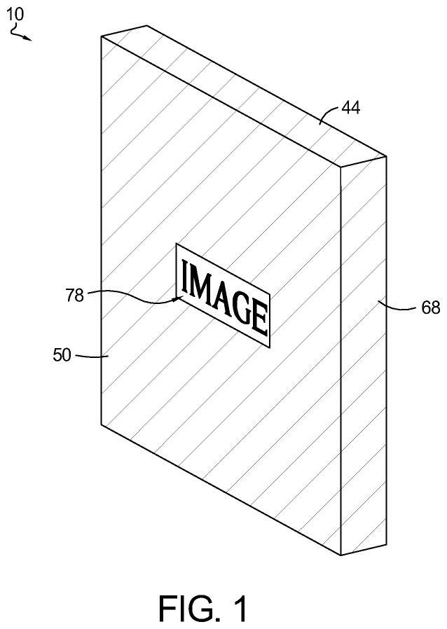

With reference to the drawings, and initially to FIG. 1, the present invention seeks to address the need for a frameless fold-over print display article 10 that begins as a flat sheet of material for printing via a photofinishing device, an at-home or point of sale printing device, such as a personal laser printer or a retail-based print kiosk. The flat sheet of material is foldable to create a self-supported, closed three-dimensional (3D) construction that does not require an underlying support structure, such as a wood frame. For instance, article 10 may constructed of a sufficiently rigid yet pliable material, such as and without limitation thereto, cardstock paper having a weight greater than 65 pounds, and more preferably between 110 to 130 pounds. Article 10 may also be foldable to any desired 3D structure, including but not limited to triangular, rectangular or square, or trapezoidal prisms.

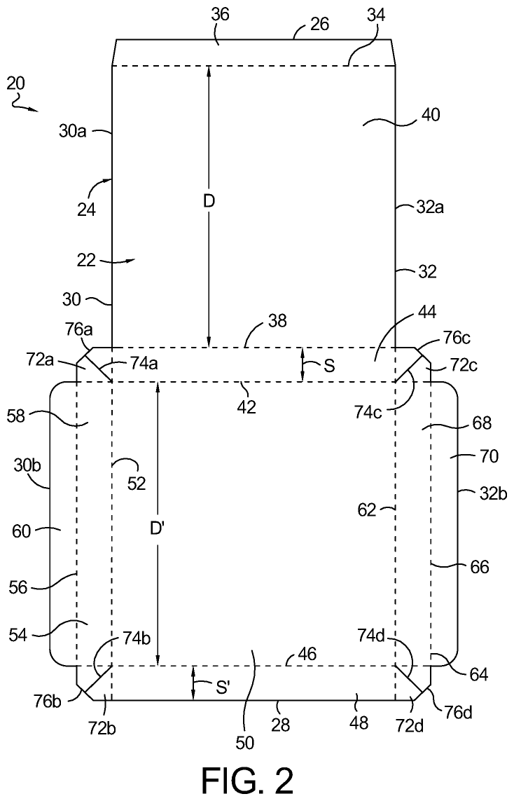

Turning now to FIG. 2, article 10 may be constructed of a panel sheet 20 having a top surface 22 and a bottom surface 24. Panel sheet 20 is bounded by a top edge 26, a bottom edge 28, a left side edge 30 and a right side edge 32. Defined within panel sheet 20 is a first score line 34 proximate top edge 26 so as to define a seal flap 36 between first score line 34 and top edge 26. A second score line 38 is located an intermediate distance D from first score line 34 and between top edge 26 and bottom edge 28. A back panel 40 is thus defined between first score line 34 and second score line 38, and between a first portion 30a of left side edge 30 and a first portion 32a of right side edge 32. A third score line 42 is located proximate second score line 38 a spaced distance S. Top panel 44 is then defined between second score line 38 and third score line 42. A fourth score line 46 is located proximate bottom edge 28 a spaced distance S′ so as to define a bottom panel 48 between fourth score line 46 and bottom edge 28. Fourth score line 46 is also a spaced distance D′ from third score line 42 to thereby define a front panel 50 between the third and fourth score lines 42, 46.

With continued reference to FIG. 2, a fifth score line 52 is arranged collinearly with the first portion 30a of left side edge 30, wherein an extended left side panel 54 is defined between fifth score line 52 and a second portion 30b of left side edge 30. Extended left side panel 54 encompasses top panel 44, front panel 50 and bottom panel 48; and third score line 42 and fourth score line 46 each traverse extended left side panel 54. A sixth score line 56 is located outwardly of fifth score line 52 proximate second portion 30b of left side edge 30. Left side panel 58 is defined between fifth and sixth score lines 52, 56 while a left side flap 60 is defined between sixth score line 56 and second portion 30b of left side edge 30.

Similarly, a seventh score line 62 is arranged collinearly with the first portion 32a of right side edge 32, wherein an extended right side panel 64 is defined between seventh score line 62 and a second portion 32b of right side edge 32. Extended right side panel 64 encompasses top panel 44, front panel 50 and bottom panel 48; and third score line 42 and fourth score line 46 each traverse extended right side panel 64. An eighth score line 66 is located outwardly of seventh score line 62 proximate second portion 32b of right side edge 32. Right side panel 68 is defined between seventh and eighth score lines 62, 66 while a right side flap 70 is defined between eighth score line 66 and second portion 32b of right side edge 32.

Panel sheet 20 may further include a plurality of corner flaps 72a, 72b, 72c, 72d. Corner flap 72a may be located at the junction of top panel 44 and extended left side panel 54; corner flap 72b may be located at the junction of extended left side panel 54 and bottom panel 48; corner flap 72c may be located at the junction of top panel 44 and extended right side panel 64; and corner flap 72d may be located at the junction of extended right side panel 64 and bottom panel 48. Each corner flap 72a, 72b, 72c, 72d may include a respective perforation line 74a, 74b, 74c, 74d and angled face 76a, 76b, 76c, 76d, each of which are configured to assist folding and supporting article 10 when panel sheet 20 is folded, as will be described in greater detail below.

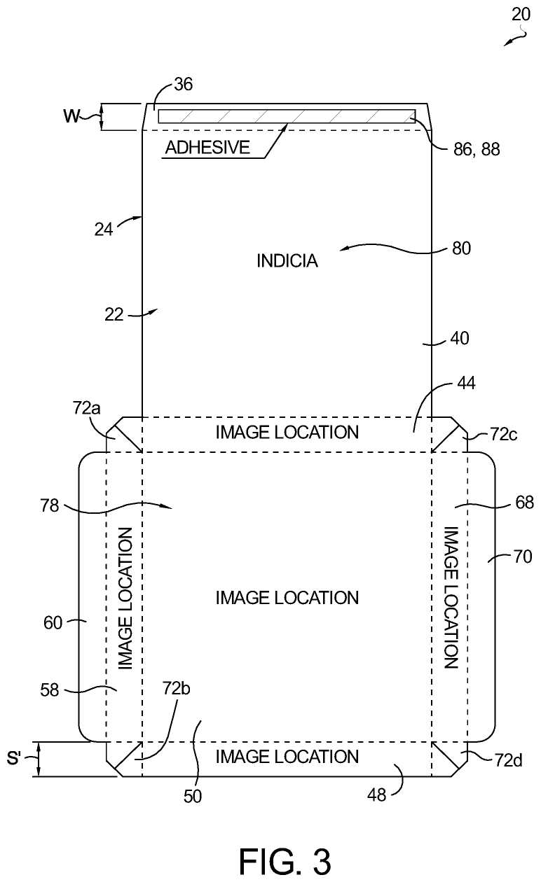

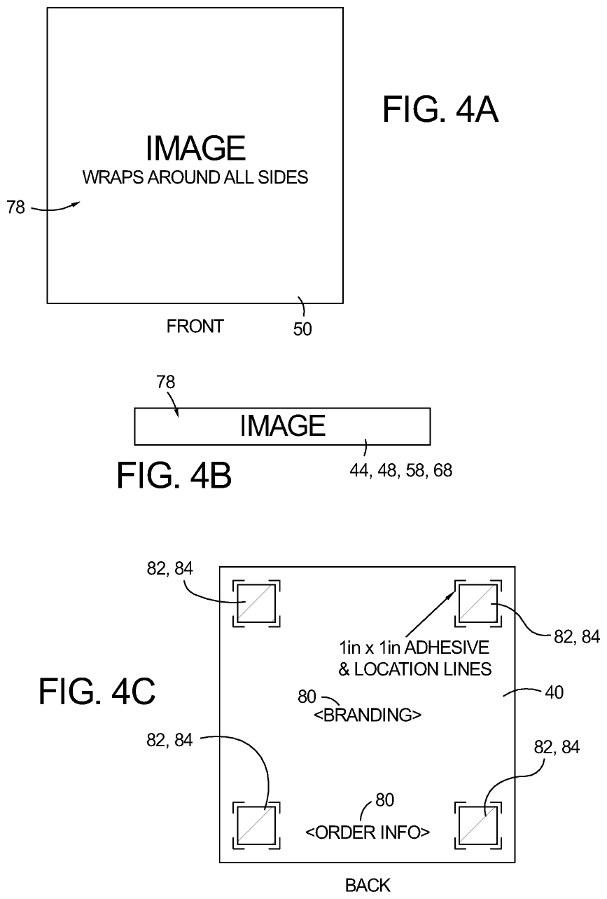

FIG. 3 generally shows a reproduction of panel sheet 20 but includes additional details related to an exemplary print layout for article 10. As shown in FIGS. 3, 4A and 4B, one or more of front panel 50, top panel 44, bottom panel 48, left side panel 58, and right side panel 68 may be a surface that is configured to allow an image 78 to be disposed thereon, such as but not limited to a photograph or artwork. For example, a single image 78 can be disposed on front panel 50, top panel 44, bottom panel 48, left side panel 58, and right side panel 68 so that the image 78 appears to wrap around all of these portions of article 10 when fully assembled as described below. It should be understood that it is also contemplated that different images be disposed on front panel 50, top panel 44, bottom panel 48, left side panel 58, and/or right side panel 68. It is also contemplated that no image be disposed on one or more of front panel 50, top panel 44, bottom panel 48, left side panel 58, and right side panel 68.

With additional reference to FIG. 4C, back panel 40 may include any desired indicia 80 disposed thereon, such as but not limited to image information such as a date and location that image 78 was captured, a copyright notice, fulfillment provider information such as trademark(s) or other branding information and/or additional information that would allow for reordering article 10 or other products including image 78 or other images. Back panel 40 may also include one or more adhesive strips 82 or indicia 84 indicating the proper location for application of one or more adhesive strips 82 to enable mounting of article 10 to a mounting surface for display.

As further shown in FIG. 3, seal flap 36 may also include an adhesive strip 86 or indicia 88 indicating the proper location for application of adhesive strip 86 on top surface 22 of panel sheet 20. In one embodiment of the present invention, a width W of seal flap 36 is equal to, or more preferably, slightly smaller than spaced distance S′ of bottom panel 48. With additional reference to FIG. 2, seal flap 36 and bottom flap 48 may then be matingly joined by folding panel sheet 20 along score lines 34, 38, 42, 46, such that adhesive strip 86 on top surface 22 of seal flap 36 may be sealingly coupled to bottom face 24 of bottom panel 48. As a result, article 10 may be formed as a closed tubular object while image 78 along bottom panel 48 remains visible. Next, perforations 74a, 74b, 74c, 74d on corner flaps 72a, 72b, 72c, 72d may be broken. Panel sheet 20 may then be folded along score lines 52, 56, 62, 66 so that left side flap 60 and right side flap 70 may be inserted within the closed tubular object to form the completed closed 3D article 10 while image 78 on left side panel 58 and right side panel 68 remain visible (see FIG. 1). In some embodiments, left side flap 60 and right side flap 70 may also include an adhesive strip 86 or indicia 88 indicating the proper location for application of adhesive strip 86. With additional reference to FIG. 2, left side flap 60 and right side flap 70 and back panel 40 may then be matingly joined by folding panel sheet 20 along score lines 34, 38, 42, 46, 52, 56, 62, 66 such that adhesive strip 86 on top surface 22 of the left side flap 60 and the right side flap 70 may be sealingly coupled to bottom face 24 of back panel 40.

With reference to FIGS. 4A-4C, shown are plan views of the front panel 50 (FIG. 4A); top, bottom and left and right side panels 44, 48, 58, 64 (FIG. 4B) and back panel 40 (FIG. 4C) of the exemplary article 10 shown in FIG. 1 after printing and folding of the panel sheet 20 as shown in FIGS. 2 and 3. As can be seen in FIGS. 4A-4C, exemplary article 10 is formed as a square prism having a nominal length and width of 8 inches. That is, distances D and D′ are 8 inches long. Each of top panel 44, bottom panel 48, left side panel 58, and right side panel 68 have a nominal depth of 1 inch. It should be noted that the above dimensions are meant to be non-limiting and are merely exemplary in nature. One skilled in the art would recognize that any closed 3D article may be produced in accordance with the teachings of the present invention upon selectively changing any one or more dimensions of one or more panel. By way of example and without limitation, bottom panel 48 may be dimensioned to have a greater depth than top panel 44. Left side panel 58 and right side panel 68 may then be formed in the shape of a trapezoid to account for the differing depths of the top and bottom panels. In this manner, an article will be produced in the shape of a trapezoidal prism.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A frameless fold-over print display article, comprising a panel sheet having a top surface and a bottom surface bounded by a top edge, a bottom edge, a left side edge and a right side edge, the panel sheet including:
a) a first score line proximate the top edge, wherein a seal flap is defined between the first score line and the top edge;
b) a second score line located an intermediate distance between the top edge and the bottom edge, wherein a back panel is defined between the first score line and the second score line and between a first portion of the left side edge and a first portion of the right side edge, wherein the first portion of each of the left side edge and right side edge encompass the seal flap and the back panel;
c) a third score line proximate the second score line and opposite the back panel, wherein a top panel is defined between the second score line and the third score line;
d) a fourth score line proximate the bottom edge, wherein a front panel is defined between the third score line and the fourth score line, wherein a bottom panel is defined between the fourth score line and the bottom edge;
e) a fifth score line collinear with the first portion of the left side edge, wherein an extended left side edge is defined between the fifth score line and a second portion of the left side edge, wherein the extended left side edge encompasses the top panel, front panel and bottom panel, and wherein the third score line and the fourth score line traverse the extended left side edge;
f) a sixth score line proximate the fifth score line and extending from the third score line to the fourth score line, wherein a left side panel is defined between the fifth score line and the sixth score line, and wherein a left side flap is defined between the sixth score line and the second portion of the left side edge;
g) a seventh score line collinear with the first portion of the right side edge, wherein an extended right side edge is defined between the seventh score line and a second portion of the right side edge, wherein the extended right side edge encompasses the top panel, front panel and bottom panel, and wherein the third score line and the fourth score line traverse the extended right side edge; and
h) an eighth score line proximate the seventh score line and extending from the third score line to the fourth score line, wherein a right side panel is defined between the seventh score line and the eighth score line, and wherein a right side flap is defined between the eighth score line and the second portion of the right side edge,
wherein the panel sheet is configured to be folded at each of first, second, third, fourth, fifth, sixth, seventh and eighth score lines to form a closed three-dimensional construction comprising the frameless fold-over print display article.

2. The frameless fold-over print display article of claim 1, wherein the first score line, the second score line, the third score line, and the fourth score line are each perpendicular to each of the fifth score line, the sixth score line, the seventh score line, and the eighth score line.

3. The frameless fold-over print display article of claim 1, wherein the panel sheet has a weight greater than 65 pounds.

4. The frameless fold-over print display article of claim 3, wherein the panel sheet has a weight between 110 pounds and 130 pounds.

5. The frameless fold-over print display article of claim 1, wherein the panel sheet further includes:
a first corner flap disposed at a junction of the top panel and the left side panel;
a second corner flap disposed at a junction of the left side panel and the bottom panel;
a third corner flap disposed at a junction of the bottom panel and the right side panel; and
a fourth corner flap disposed at a junction of the right side panel and the top panel.

6. The frameless fold-over print display article of claim 5, wherein each of the first corner flap, the second corner flap, the third corner flap, and the fourth corner flap has an irregular pentagon shape.

7. The frameless fold-over print display article of claim 6, wherein each of the first corner flap, the second corner flap, the third corner flap, and the fourth corner flap includes a perforation line bisecting the irregular pentagon.

8. The frameless fold-over print display article of claim 1, may comprise at least one adhesive strip.

9. The frameless fold-over print display article of claim 8, wherein the seal flap is configured to align with and be matingly joined to the bottom panel via the adhesive strip.

10. The frameless fold-over print display article of claim 8, wherein the at least one adhesive strip includes a plurality of adhesives strips.

11. The frameless fold-over print display article of claim 10, wherein the left side flap and right side flap are configured to be matingly joined to the back panel via a portion of the plurality of adhesive strips.
